(19) United States
(12) Patent Application Publication
(10) Pub. No.: US 2002/0077967 A1
(43) Pub. Date: Jun. 20, 2002

(54) Automated construction loan administration method and system

(76) Inventors: David Ingram, Greenville, SC (US); John Hollingsworth, Simpsonville, SC (US); Robert Baddorf, Lyman, SC (US)

Correspondence Address: DORITY & MANNING, ATTORNEYS AT LAW, P.A., P.O. BOX 1449, Greenville, SC, 29602, US

(21) Appl. No.: 09/976,461

(22) Filed: Oct. 12, 2001

Related U.S. Application Data
(60) Provisional application No. 60/240,172, filed on Oct. 13, 2000.

(51) Int. Cl. G06F 17/60

(52) U.S. Cl. 705/38

(57) ABSTRACT

A method and system for automatically administering a loan via a web-based communications network is disclosed. This system is based on a controlled relationship between a borrower and inspector, both parties requiring proper registration and certification based on established system requirements. Rather than a direct loan to the borrowers, monetary funding for a loan is supplied by a lender who supplies a funding account managed by system administration. Various draws on the loan may be obtained after proper incremental approval of corresponding elements of the borrower's project. A system administrator controls all aspects of these relationships and also manages system tools that are utilized for approving certain system processes. Underwriting processes are available to the system for analyzing computerized applications. The method and system may specifically be practiced with a construction system, such as for home builders, that administers automated construction financing. Such an embodiment establishes a more involved relationship between builder and dealer, involving building supplies as well as funding. The builder system also embraces specific system features such as project portfolio management, tutorials and message boards.

### PRIORITY CLAIM

This application claims the benefit of previously filed U.S. Provisional Patent Application with the same title and inventors as present, assigned U.S. Ser. No. 60/240,172, filed on Oct. 13, 2000, and which is incorporated herein by reference.

### BACKGROUND OF THE INVENTION

The present invention relates to a method and system for automatically administering a loan and, more particularly, to a method and system for providing a multi-level builders program featuring integrated, automated “on-line” construction financing and ordering of building supplies.

The process of constructing and financing a building project involves many entities and multiple procedures, resulting in a complex and often inconvenient, time consuming process. Many independent builders must typically establish multiple separate business relationships with dealers for obtaining requisite construction supplies as well as with lenders for obtaining financial means (funding) for such supplies and labor. These partnerships are inherently accompanied by complications relative to the builder's project.

Construction financing is an imperative prerequisite for most building projects, enabling the purchase of building locations (i.e., sites) and necessary supplies as well as providing for adequate project labor. Construction financing has typically been provided in many instances by traditional banking institutions that cater to the financial needs of multiple entities. Such institutions often have not given proper prioritization to loans specific to construction needs. Mergers and acquisitions in the banking industry have contributed to lower levels of service for construction loans. Loan officers with expertise in local markets and businesses are often transferred or discharged to meet the changes of a dynamic marketplace. Thus, traditional sources of financing are hard to come by, forcing a builder to explore alternative options.

Obtaining a construction loan is only ah initial step in a builder's financial arrangements. Construction loans are most often tied specifically to the various stages established or steps completed in a project plan. Draws are specific to and requested for different components of a construction project. In order to obtain a new funding draw, proper project inspection must be undertaken in order to ensure the timely completion of a certain stage. Alternatively, the purpose of inspection may be to establish a partial completion of a step, warranting the issuance of a corresponding partial payment, e.g., 50% completion of roof garners 50% payment for the roof step. The timetable involved in a draw request, project inspection and subsequent draw approval can be a lengthy extension to construction financing arrangements, and a cause of delay in an overall construction project timeline.

Another essential aspect of home construction is the necessity for building supplies. Such materials need to be of suitable quality and also need to be purchased, delivered and utilized in a competitive, orderly and timely manner. There are different supplies and resources employed in each stage of development, and these supplies often come from individual retailers who are not necessarily affiliated with one another. Thus, a coordination of retailers and supply needs is essential to smooth project operation. From a dealer's perspective, a construction client has numerous options in choosing what supplies will be obtained from a specific retailer. Thus, a desire arises for a dealer to retain a builder's entire supply business.

Specific monetary supply and building supply relationships for a builder have typically been distinct from one another. In a more general embodiment, a lender, an inspector and a dealer for a loan borrower's project are typically unique, respective business associates. This apportionment of resources proves to be an inherent obstacle for achieving and maintaining convenient as well as expedient project development. As such, there is currently no way of encompassing all a borrower's needs into one integrated relationship while addressing the intrinsic problems that stem from these individual needs.

### SUMMARY OF THE INVENTION

In view of the discussed drawbacks and shortcomings encountered in the prior art, an improved method and system for administering a loan has been developed. Broadly speaking, a general object of the invention is an improved method and system for administering loans.

It is a principal object of the present invention to provide an automated system for administering a loan, the system having a borrower, characterized as the entity who desires a loan.

It is another principal object of the present invention to provide an automated system for administering a loan, the system having an inspector, characterized as the entity who enters a business relationship with a borrower and who oversees certain aspects of subsequent loan and draw processes.

It is a further general object of the present invention to provide an automated system for administering a loan, the system having a system administrator, characterized as the entity who oversees a borrower/inspector relationship and has control over various system processes, including obtaining money and disbursing it to a borrower or other third party.

It is a yet another general object of the present invention to provide an automated system for administering a loan, the system having a lender, characterized as the entity who supplies monetary means for the loan.

It is a further object of the present invention to provide a computerized method for a borrower to be involved in automated financing, the method including a registration process, a certification process, a loan application process, and a draw request process.

It is a further object of the present invention to provide a computerized method for an inspector to be involved in automated financing, the method including a registration process, a certification process and an inspection procedure required for draw payment approval.

It is a further object of the present invention to provide a computerized method for an administrative unit to automatically control the business arrangements and financing, this method accounting for borrower certification, inspector certification, loan approval and draw request approval.

It is a further object of the present invention to provide various “offline” automatic underwriting processes, such processes utilized as an initial means for approving certain elements of the loan administration process. Underwriting processes are employed during respective certifications of the borrower and inspector as well as during project closing. The processes are further employed for project plan assessment and borrower loan application assessment. Additional “offline” processes incorporate automatic system auditing to ensure quality control of system functions.

It is yet another object of the present invention to provide an automated method and system for providing construction loans, such system including a builder (synonymous with a borrower), a dealer (synonymous with an inspector), a system administrator and a lender.

It is further object of the present invention to provide a funding account that is controllably accessible by dealers and builders and possibly by subcontractors under the builders, with the possibility of electronic funds disbursement available to all parties with access to the account.

It is a further object of the present invention to provide controlled flow of building supplies provided to a builder by a dealer or by other entities subcontracted by the dealer.

It is another present object to provide detailed reports and information services as related to a computerized construction system. Such reporting services include without limitation project tracking, account management, project portfolio maintenance and various marketing modules. Other information services may include tutorials for aided instruction of system components and functions as well as message boards oriented towards specific system participants.

It is another present object to offer automated insurance for projects that are managed by the construction loan system, such insurance having varied options for specific projects.

It is a further present object to provide such improved methodology and system in an integrated web-based design.

Further objects of the present invention will become apparent during a specified description of the invention with reference to detailed drawings. Additional objects and advantages of the invention are set forth in, or will be apparent to those of ordinary skill in the art from, the detailed description herein. Also, it should be further appreciated that modifications and variations to the specifically illustrated and discussed features or processes hereof may be practiced in various embodiments and uses of this invention without departing from the spirit and scope thereof, by virtue of present reference thereto. Such variations may include, but are not limited to, substitution of equivalent means and features, materials, or steps for those illustrated or discussed, and the functional, operational or positional reversal of various parts, features, steps, or the like.

Still further, it is to be understood that different embodiments, as well as different presently preferred embodiments, of this invention may include various combinations or configurations of presently disclosed features or elements, or their equivalents (including combinations of features or steps or configurations thereof not expressly shown in the figures or stated in the detailed description). One exemplary embodiment of the present invention relates to an automated method and system for administering loans, such system including a borrower, an inspector and a system administrator. A borrower and an inspector engage in a business relationship relating to subsequent loan and draw process. A system administrator oversees the borrower/inspector relationship and has control over various system processes, including obtaining money and disbursing it to a borrower or other third party. Such embodiment may further include a lender who supplies funding for the loan.

Yet another exemplary embodiment of the present invention involves an automated system for providing construction financing, the system having a system administrator, a builder, a dealer and a lender. A builder is synonymous with a borrowing entity related to construction loans and a dealer is synonymous with an inspecting entity in the same field A system administrator maintains control over various aspects of the system. This system further comprises a funding account that is controlled by the administrative unit and supplied with funding means (i.e., capital) provided by one or more lenders. The funding account is controllably accessible by dealers and builders and possibly by subcontractors under the builders, with the possibility of electronic funds disbursement available to all parties with access to the account. The system further incorporates controlled flow of building supplies provided to a builder by a dealer or other entities subcontracted by a dealer.

Additional embodiments of the subject invention, not necessarily expressed in this summarized section, may include and incorporate various combinations of aspects of features or steps referenced in the summarized objectives above, and/or other features or steps as otherwise discussed in this application.

Those of ordinary skill in the art will better appreciate the features and aspects of such embodiments, including process steps, and others, upon review of the remainder of the specification.

### BRIEF DESCRIPTION OF THE DRAWINGS

FIG. 1 is a block diagram representing an exemplary embodiment of system control and participant interaction in accordance with the present invention.

FIG. 2 is a block diagram illustrating an exemplary embodiment of the present invention, in a building loan specific embodiment thereof.

FIGS. 3A through 3C illustrate exemplary elements of the invention method performed by various system entities. In accordance with an embodiment of the invention, these three figures correspond respectively to entities referred to as the borrower, inspector and administrator.

FIG. 4 is a flow chart illustrating an exemplary registration process of a builder, or of a borrower in accordance with various embodiments of the present invention.

FIG. 5 is a flow chart illustrating an exemplary registration process of a dealer, or of an inspector in accordance with various embodiments of the present invention.

FIG. 6 is a flow chart illustrating an exemplary certification process of a builder, or of a borrower in accordance with various embodiments of the present invention.

FIG. 7 is a flow chart illustrating an exemplary certification process of a dealer, or of an inspector in accordance with various embodiments of the present invention.

FIG. 8 is a flow chart illustrating an exemplary builder loan application process in accordance with various embodiments of the present invention.

FIG. 9 is a flow chart depicting an exemplary administrative tool utilized for builder certification, or for borrower certification in accordance with various embodiments of the present invention.

FIG. 10 is a flow chart depicting an exemplary administrative tool utilized for dealer certification, or for inspector certification in accordance with various embodiments of the present invention.

FIG. 11 is a flow chart depicting an exemplary administrative tool utilized in the builder loan application and approval process in accordance with an embodiment of the invention.

FIG. 12 is a flow chart depicting an exemplary administrative tool utilized in draw request processing in accordance with an embodiment of the invention.

FIG. 13 is a flow chart illustrating an exemplary underwriting process employed for builder certification in accordance with an embodiment of the present invention.

FIG. 14 is a flow chart illustrating an exemplary underwriting process employed for dealer certification in accordance with an embodiment of the present invention.

FIG. 15 is a flow chart illustrating an exemplary underwriting process utilized in the loan application process in accordance with an embodiment of the present invention.

FIG. 16 is a flow chart illustrating an exemplary closing process in accordance with an embodiment of the present invention.

FIG. 17 is a flow chart illustrating an exemplary process for assessing the project plan in accordance with an embodiment of the present invention.

### DETAILED DESCRIPTION OF THE DRAWINGS

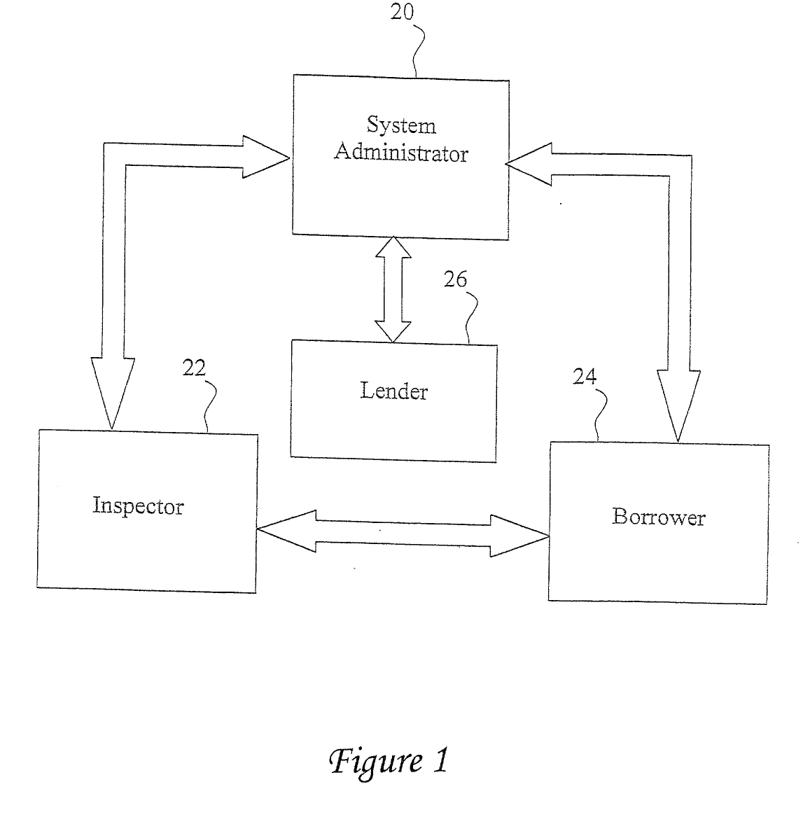

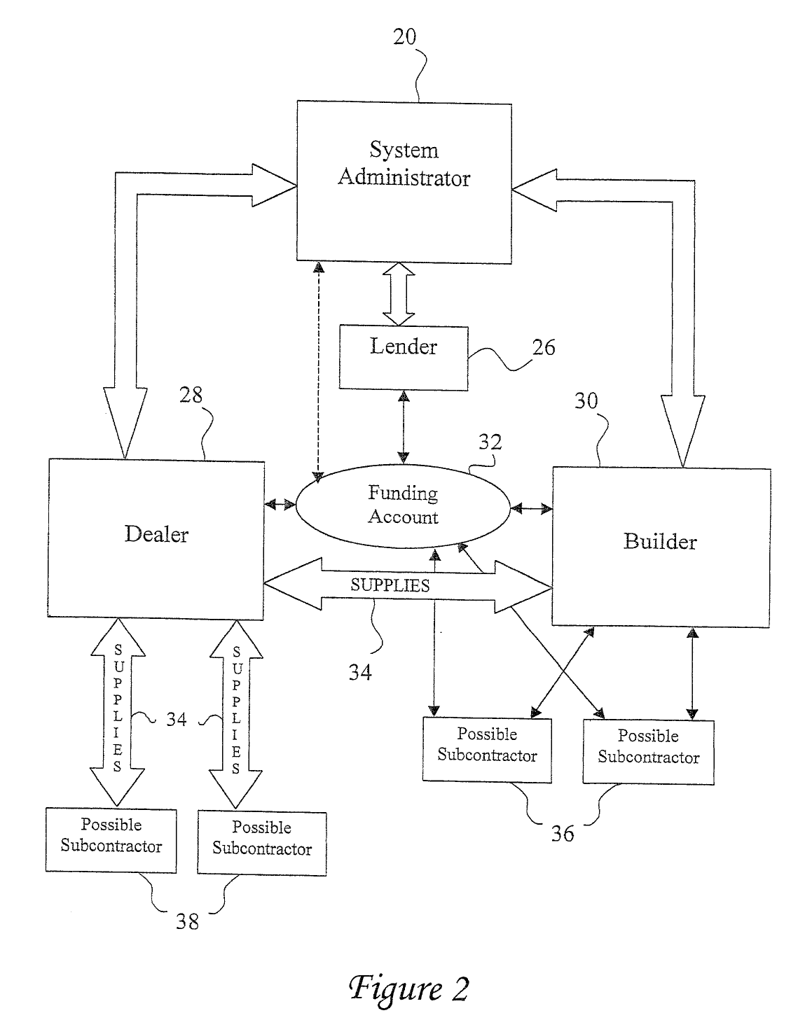

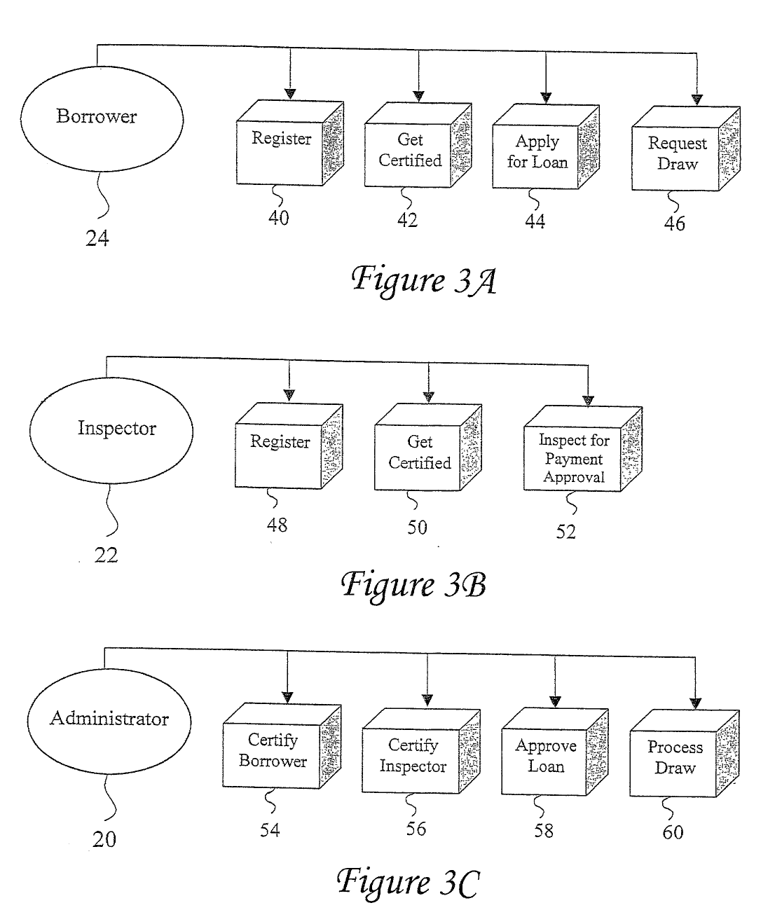

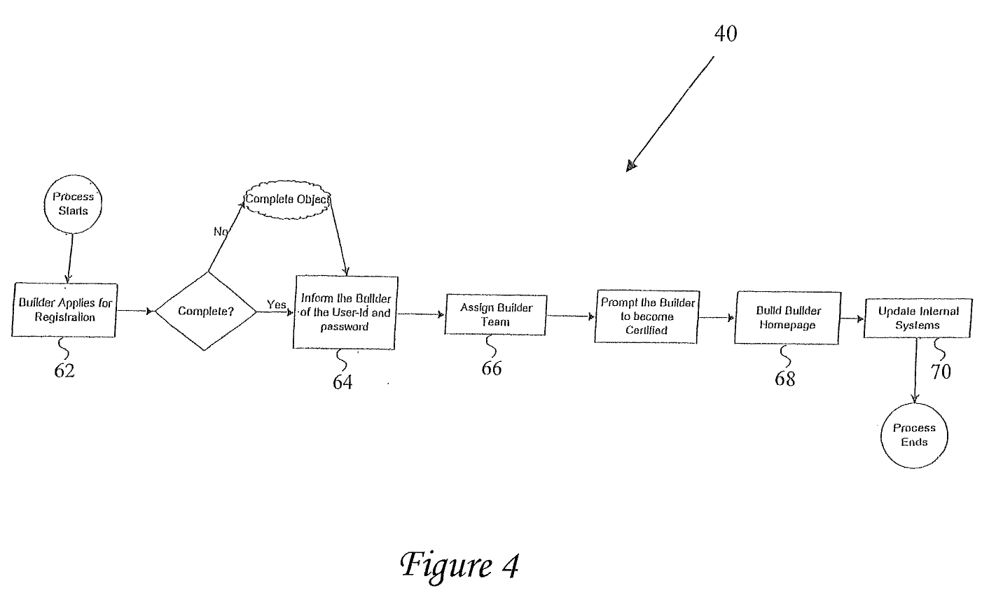

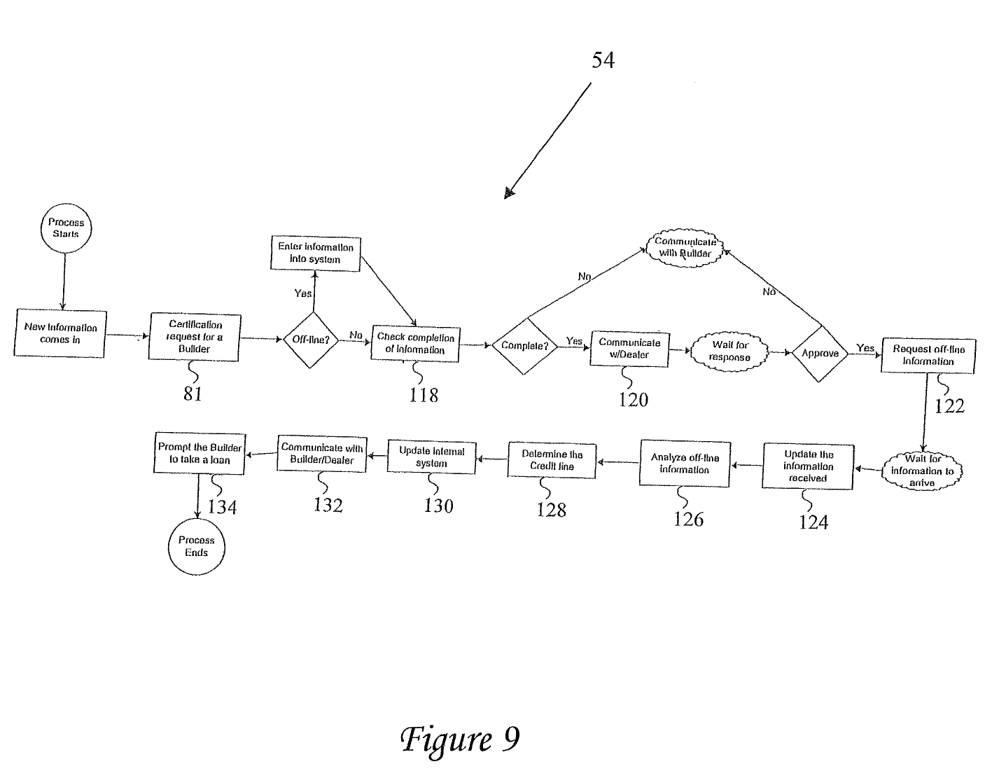

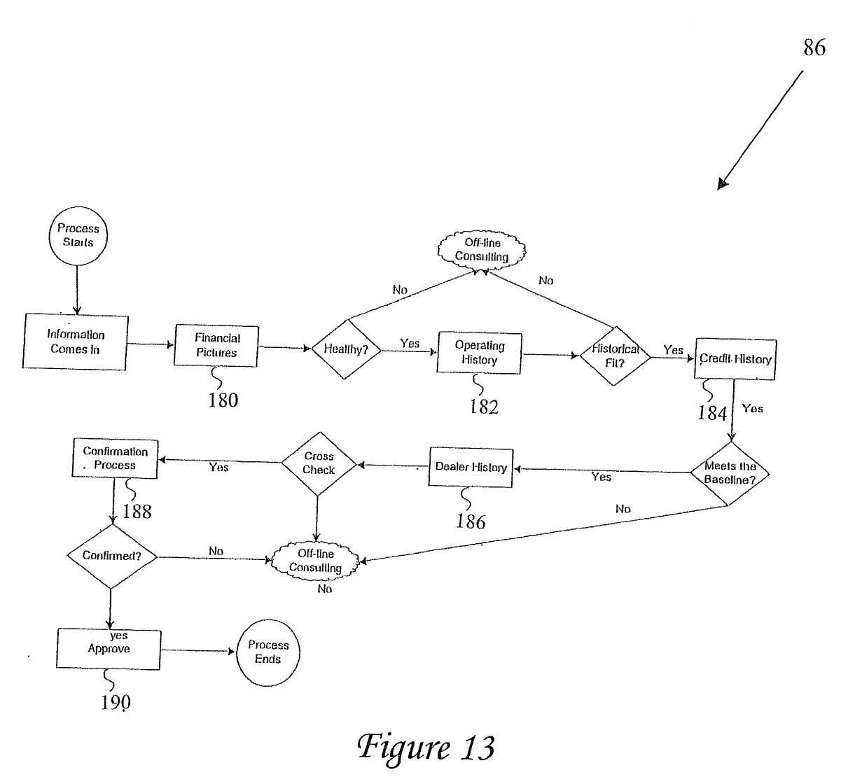

The present invention includes both a method and system for automatically administering loans, such system including a borrower, an inspector and a system administrator. A general embodiment of this system is referenced by the drawings disclosed in FIG. 1 and FIGS. 3A through 3C. Various entities in accordance with a general embodiment are also present in a more specific embodiment of the invention that relates to a method and system for automatically administering construction loans, such system disclosed in FIG. 2. This more specific embodiment specifies a borrowing entity to be a home builder and an inspecting entity to be a building supply dealer. All other figures disclose specific processes of a system and method that may be associated with various embodiments of the present invention. FIGS. 4 through 8 illustrate various system components that relate to builder and dealer processes. The processes illustrated in FIGS. 4 through 8 may also relate to a borrower and inspector in accordance with various embodiments of the present invention. FIGS. 9 through 12 illustrate administrative tools that are utilized by a system administrator in order to control various processes available in the system. FIGS. 13 through 17 display several underwriting processes that speed up and automate system decisions and make it easier, effective and efficient for builders to gain loans.

Referring now to the drawings, FIG. 1 is a block diagram illustrating an exemplary relationship of control and interaction among system entities. Such a loan administration system includes a borrower 24, a lender 26, an inspector 22, and a system administrator 20. A borrowing entity 24 desires the loan; an inspecting entity 22 enters a business relationship with the borrower 24 and oversees certain aspects of subsequent loan and draw processes; an administrative entity 20 oversees the borrower/inspector relationship and has control over system processes, including obtaining money and disbursing it to the borrower 24 or other third party; a lender 26 supplies monetary means for the loan, but is not directly involved with the borrower/inspector relationship.

FIG. 2 is a block diagram illustrating a specific embodiment of the present invention as it relates to an automated system for providing construction financing, such web-based system having a system administrator 20, a builder 30, a dealer 28 and a lender 26. A builder 30 is synonymous with the borrowing entity 24 but related to construction loans and a dealer 28 is synonymous with the inspecting entity 22 in the same field. A system administrator 20 still maintains control over various aspects of the system. This system further comprises a funding account 32 that is controlled by an administrative unit 20 and supplied with funding means (i.e., capital) provided by a lender 26. The funding account 32 is controllably accessible by a dealer 28 and a builder 30 and possibly by subcontractors under a builder 36, with the possibility of electronic funds disbursement available to all parties with access to the account. The system further incorporates controlled flow of building supplies 34 provided to a builder 30 by a dealer 28 or other entities subcontracted by a dealer 38.

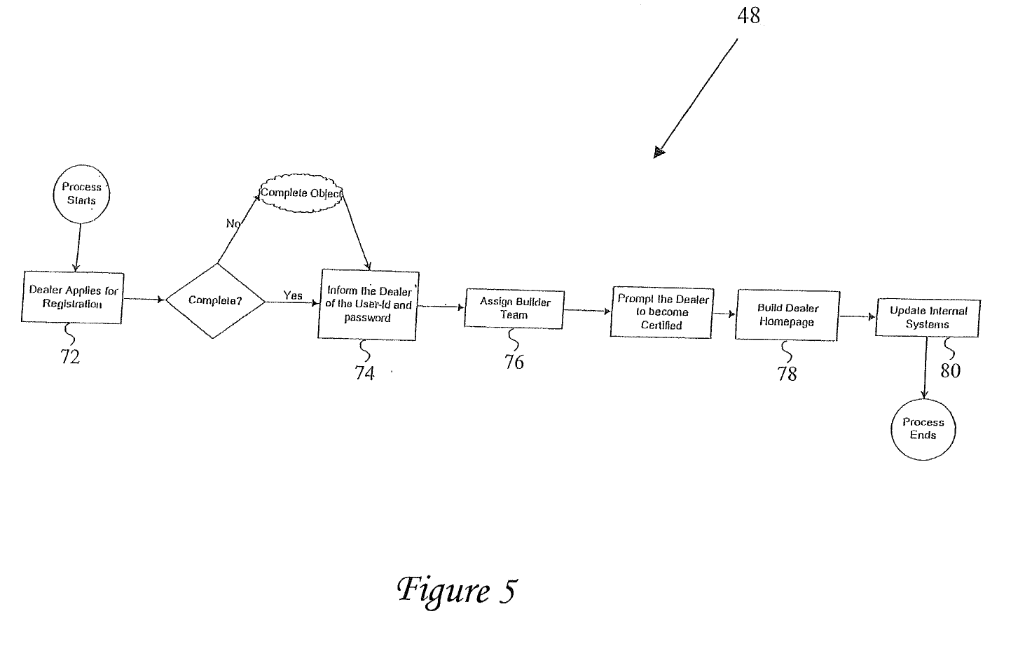

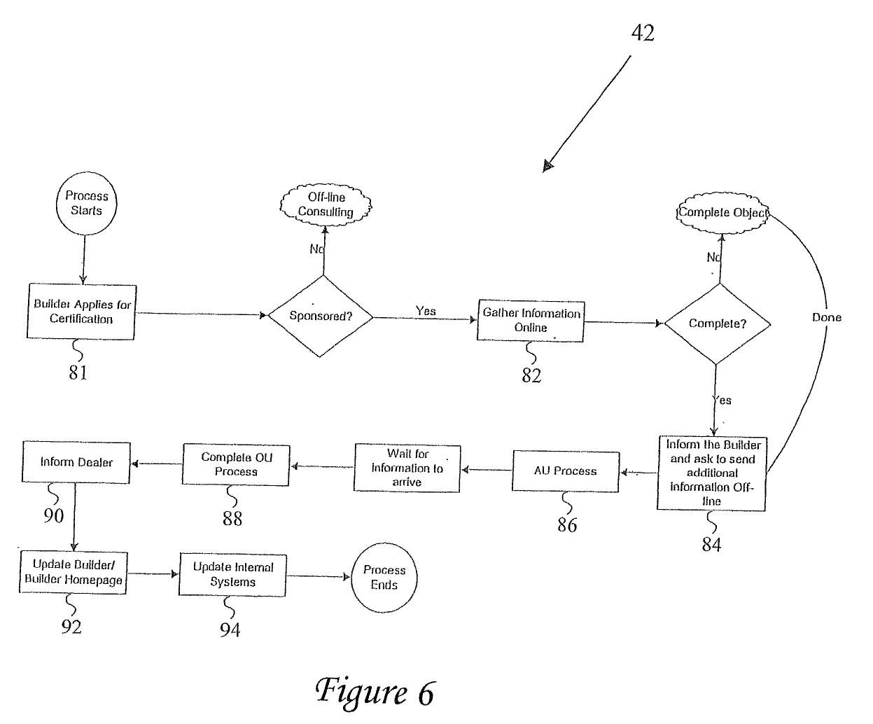

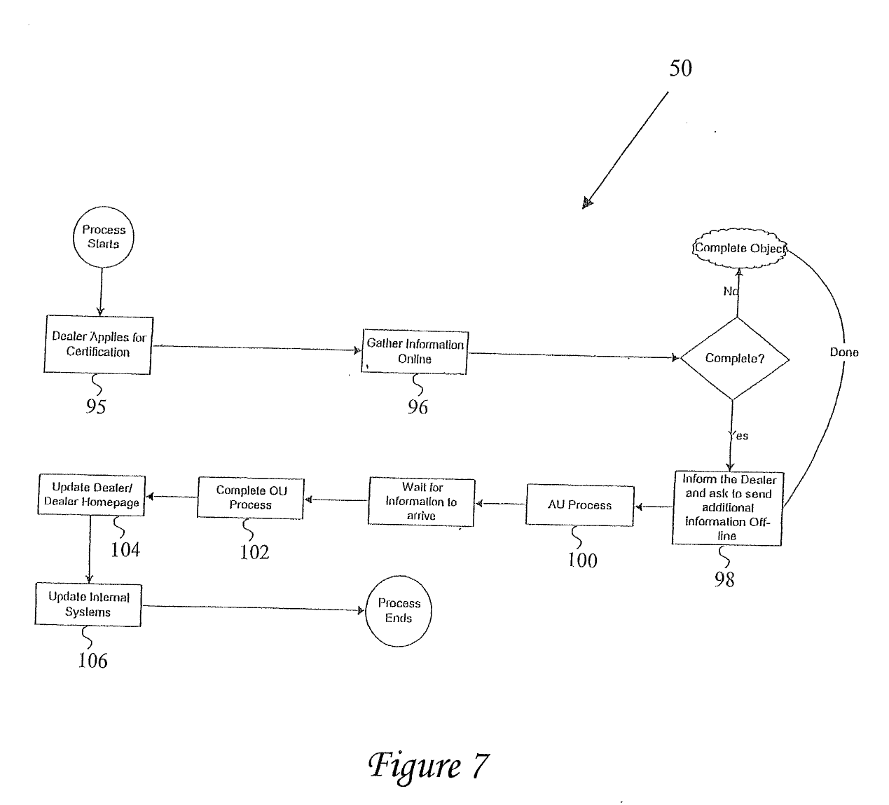

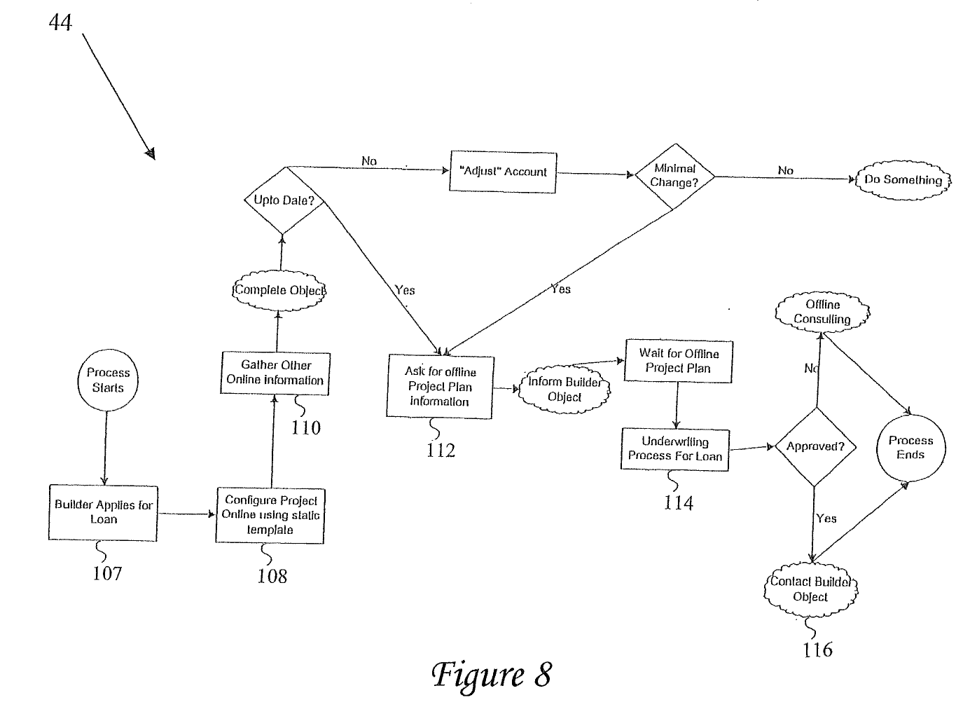

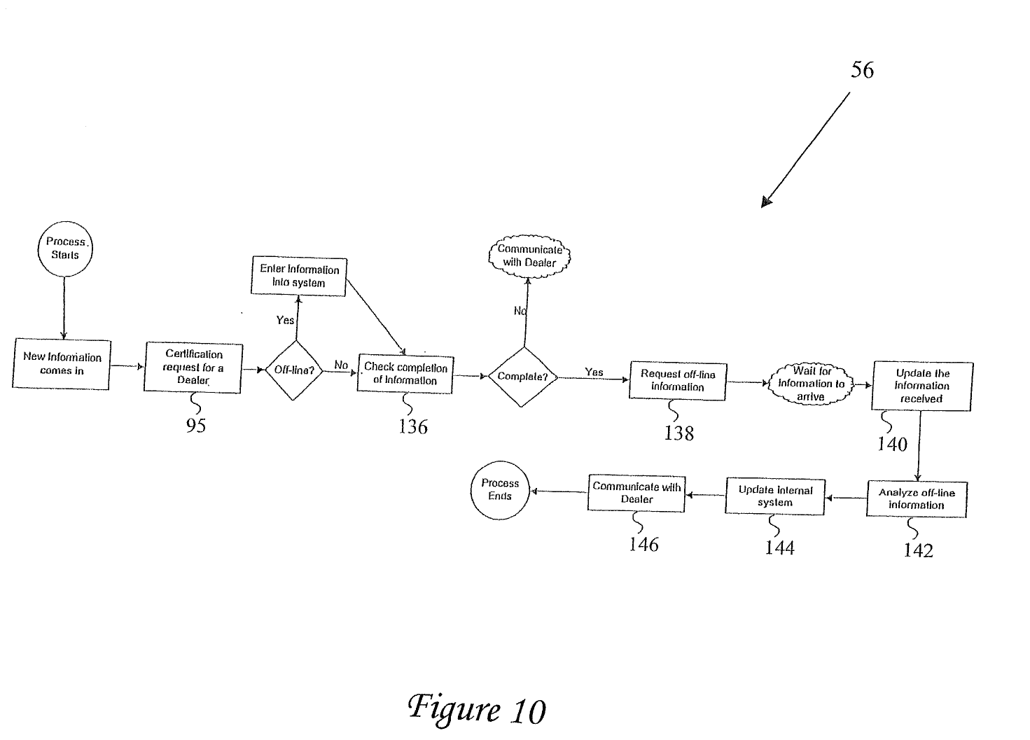

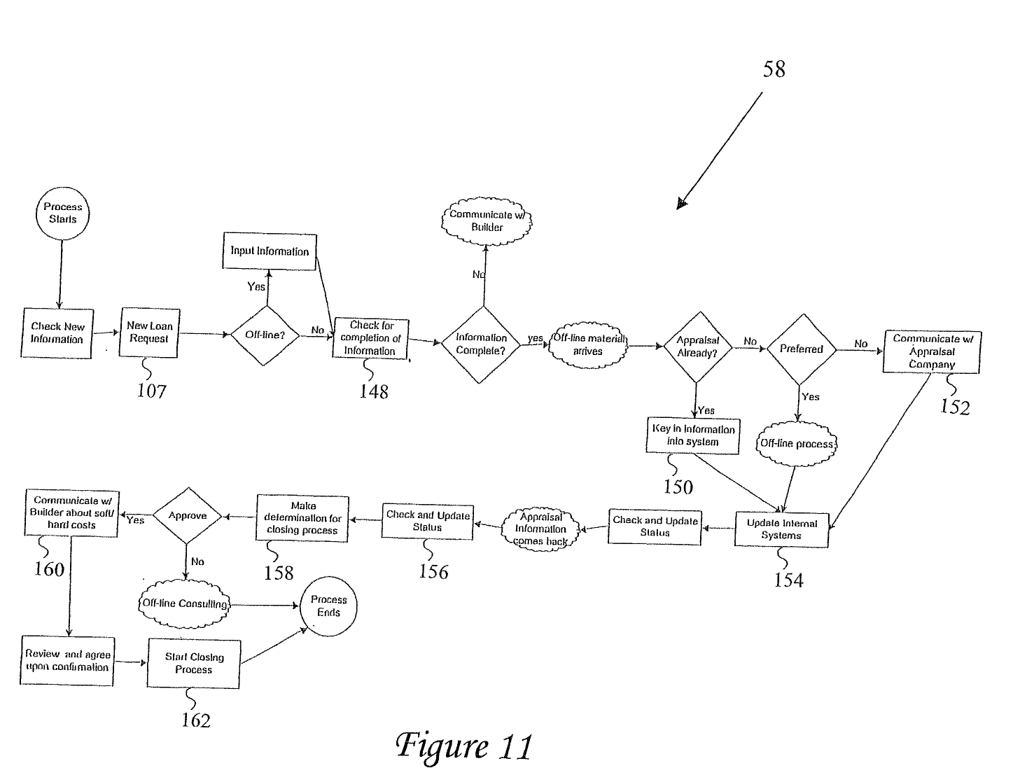

FIGS. 3A through 3C depict exemplary processes performed by various system entities in accordance with a method of the invention. FIG. 3A illustrates exemplary processes undertaken by a borrower 24, or by a builder in accordance with a more specific embodiment of the invention. Processes available to the borrower 24 include registering in the system 40, obtaining borrower certification 42, applying for a loan 44 and requesting a draw 46 on a loan. FIG. 3B illustrates exemplary processes undertaken by a inspector 22, or by a dealer in accordance with a more specific embodiment of the invention. Processes accessible by an inspector 22 include registering as an inspector 48, obtaining proper certification 50 and approving a draw payment through proper project inspection 52. FIG. 3C illustrates exemplary processes undertaken by a system administrator 20. A system administrator 20 controls various processes included in the system. Of particular utilization are the processes related to borrower certification 54, inspector certification 56, loan approval 58 and draw processing 60. FIG. 4 is a flow diagram illustrating an exemplary process 40 used to register as a builder. The registration process begins when a builder enters the online server system and applies for registration 62. A builder is prompted to supply various personal statistics as an initial step. Once the necessary data is provided, a builder is automatically informed of their unique user name and password 64 for future access to the system. A registered builder is then assigned to a Builder Team 66 by the zip code supplied during registration. A builder home page is then generated 68, such homepage created to provide a builder with access to valuable account information. Internal systems are then updated 70 with the newly saved registration information and a final step of the process is to prompt a builder to become certified. FIG. 5 is a flow diagram illustrating an exemplary process 48 used to register a client as a dealer. This registration process begins when a dealer enters the online server system and applies for registration 72. Once the necessary data is provided, a dealer is automatically informed of their unique user name and password 74 for future access to the system. A registered dealer is then assigned to a Builder Team 76, members of which a dealer will supply construction materials to. A dealer home page is then generated 78, such homepage created to provide a dealer with access to valuable account information. Internal systems are then updated 80 with the newly saved registration information and a final step of the process is to prompt a dealer to become certified. FIG. 6 is a flow diagram illustrating an exemplary process 42 used for builder certification. A builder goes to his generated website and applies for certification 81. Various online information is requested and subsequently gathered from a builder 82, such information including specific personal, financial and business related facts. Once the required information is completely entered, a builder is informed to send required offline information 84. A system administrator starts the process of certification by going through the submitted online information and implementing an automatic underwriting process 86. A system administrator then waits for offline information to become available. Once this is available, any pertinent information is manually entered into the system and then analyzed 88. Confirmation is then obtained from a dealer 90 of the fact that they have been chosen as a sponsor by a particular builder. The builder and dealer are then updated on the results of the certification process 92. Finally, a builder homepage 92 and any related internal information systems 94 are also updated. FIG. 7 is a flow diagram illustrating an exemplary process 50 used for dealer certification. A dealer goes to its generated website and applies for certification 95. Various online information is requested and subsequently gathered from a dealer 96, such information including specific business and contact facts. Once the required information is completely entered, a dealer is informed to send required offline information 98. A system administrator starts the process of certification by going through the submitted online information and implementing an automatic underwriting process 100. A system administrator then waits for offline information to become available. Once this is available, any pertinent information is manually entered into the system and then analyzed 102. A dealer and their corresponding homepage is then updated 104 on the results of the certification process 50. Subsequently, any related internal information systems are also updated 106. FIG. 8 is a flow diagram illustrating an exemplary process 44 used in a builder's loan application process. A builder goes to its respective website and requests to apply for a loan 107. A detailed description of a project plan is submitted with the convenience of many online static project templates 108. Various other online information is requested 110 and subsequently completed by a builder. System administration starts the process of loan approval by going through the submitted online information. A system administrator then requests offline project plan information 112 and waits for it to become available. Once this is available, any pertinent information is manually entered into the system and then analyzed in conjunction with an automatic underwriting process 114 developed specifically for this information. A builder and respective dealer are contacted 116 and informed of the loan application's status. FIG. 9 is a flow diagram depicting an exemplary administrative tool 54 employed for builder certification. Members of system administration utilize this tool to proactively manage the process of making sure that the procedure associated with builder certification is efficiently and effectively executed. Once a builder has been registered, new information is available to the system. Such information is made available upon request for builder certification 81. The system internally establishes the completion of all necessary online information 118. Communication with a dealer is established 120 in order to approve a corresponding builder/dealer relationship and other aspects. Off-line information is now requested 122 as related to a builder. Once the information arrives, the system is updated 124 with the received data. The off-line information is analyzed 126 and a credit line is determined 128 from this information. All internal systems 130 as well as a respective builder and dealer 132 are then updated about the builder certification process. As soon as a builder establishes certification, they are eligible to take a loan and are thus automatically prompted to do so 134. FIG. 10 is a flow diagram depicting an exemplary administrative tool 56 employed for dealer certification. Members of system administration utilize this tool to proactively manage the process of making sure the procedure associated with dealer certification is efficiently and effectively executed. Once a dealer has been registered, new information is available to the system. Such information is made available upon request for dealer certification 95. The system internally establishes completion of necessary online information 136. Off-line information is then requested 138 as related to a dealer. Once the information arrives, the system is updated 140 with the received data. Off-line information is analyzed 142 to determine if dealer certification is to be issued. Internal systems are updated 144 relative to this information and a dealer is contacted 146 with a certification status update. FIG. 11 is a flow diagram depicting an exemplary administrative tool 58 utilized in the builder loan application process. Members of system administration utilize this tool to proactively manage the process of making sure the procedure associated a loan product is efficiently and effectively executed. A builder may apply for a loan only after they have been registered and certified in the web-based system. Such an administrative tool automatically checks new builder information and also checks for completion of information 148 upon a builder's loan request 107. If certain data is missing, then communication with a builder obtains such deficient information. During the loan application underwriting process, project appraisal information is requested from a third party vendor. If this appraisal is available to the system, then the information is keyed into the system 150. If not, communication is established with an appraisal company 152. Internal systems are then updated 154 with the new project information. While information is being received from an appraisal company, loan status is constantly checked and updated 156 relative to the newly available data. Once all pertinent information is available to the system, the administrative tool enables a final decision 158 on whether or not to approve the loan closing process. If the process is initialized, then communication is established with a builder 160 to discuss pricing figures for loan funding. The process ends when a cost outline is instituted and a final closing process starts 162.

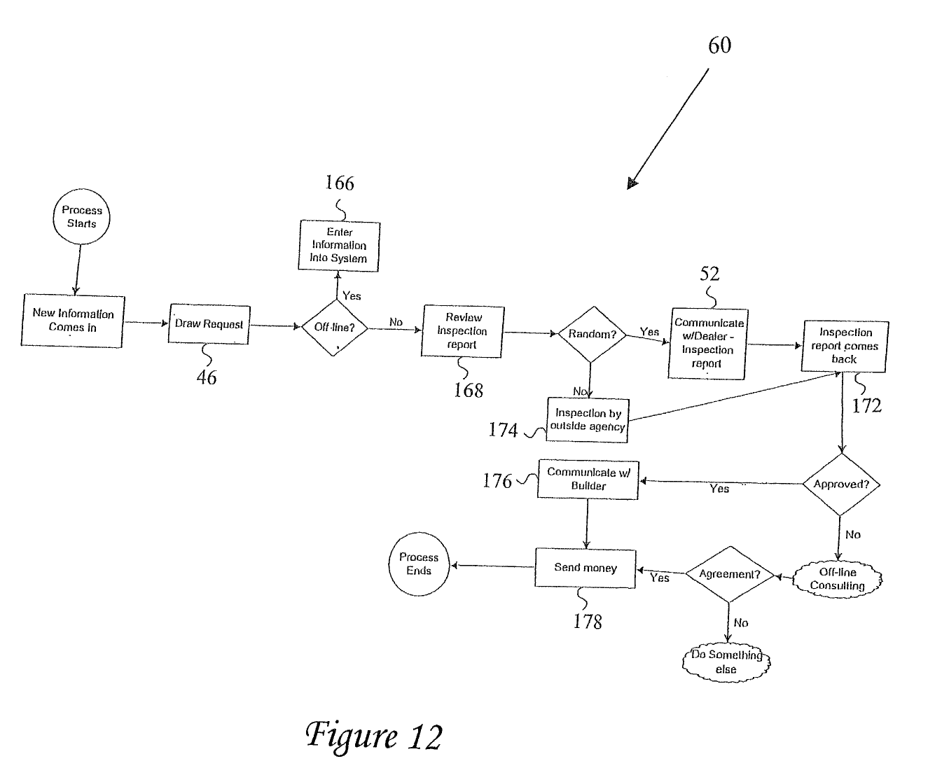

FIG. 12 is a flow diagram depicting an exemplary administrative tool 60 utilized in draw request processing. Once a certified builder has been approved for a loan, the builder would take advantage of the dynamic draw request product offered by the system. Members of system administration utilize the tool to proactively manage the process of making sure the procedure associated with draw requests and approvals is efficiently and effectively executed. Upon a builder's draw request 46, any new information is entered into the system. A significant aspect of approving a draw request 46 is a review of an inspection report 168. If this is unavailable, then there are various possible courses of action depending on who will perform the project inspection. If a dealer is to inspect the project (a typical occurrence), then communication is established with a dealer 52. It is also possible that the inspection will be performed by an outside agency 174 not associated with a dealer. Regardless of who performs the inspection, an inspection report comes back to the system 172. If the inspection report is approved, then communication with a builder is established 176 to inform them of the process status. Funding is sent accordinglyl78 and the process is complete.

FIG. 13 is a flow diagram illustrating an exemplary underwriting process 86 employed for builder certification. The objective of this process is to speed up and automate the process of underwriting of builder certification. An initial step in this process is to gather available, pertinent information related to a builder. System administration then analyzes the financial healthiness of a builder 180 based on builder registration. A similar analysis based on builder registration is performed to analyze operating history 182 and credit history 184 of a builder. It is recommended that a builder's history of operation go along well with typical system priorities. A builder's credit history must also meet base line requirements. A dealer is then contacted 186 to crosscheck a builder's historical information. System administration then makes a decision on confirmation of certification 188. Upon certification approval 190, a builder, a dealer and any related information systems are updated on the results of the certification process.

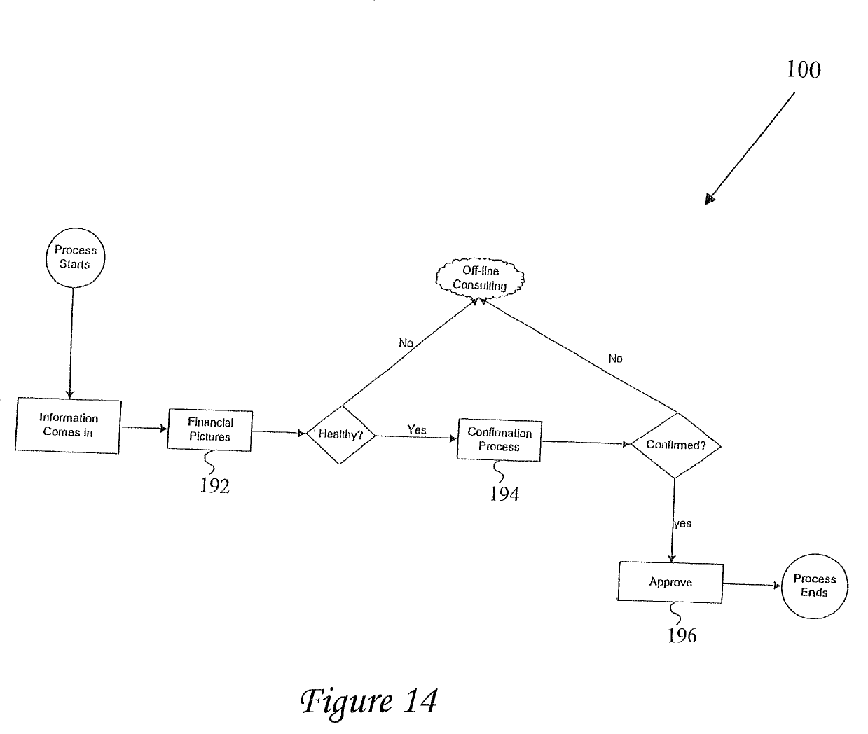

FIG. 14 is a flow diagram illustrating an exemplary underwriting process 100 employed for dealer certification. The objective of this process is to speed up and automate the process of underwriting of dealer certification as much as possible. An initial step in this process is to gather available, pertinent information related to a dealer. System administration then analyzes the financial healthiness of a dealer 192 based on dealer registration. System administration then makes a decision on confirmation 194 of this certification process. Upon certification approval 196, a dealer and builder as well as any related information systems are updated on the results of the certification process.

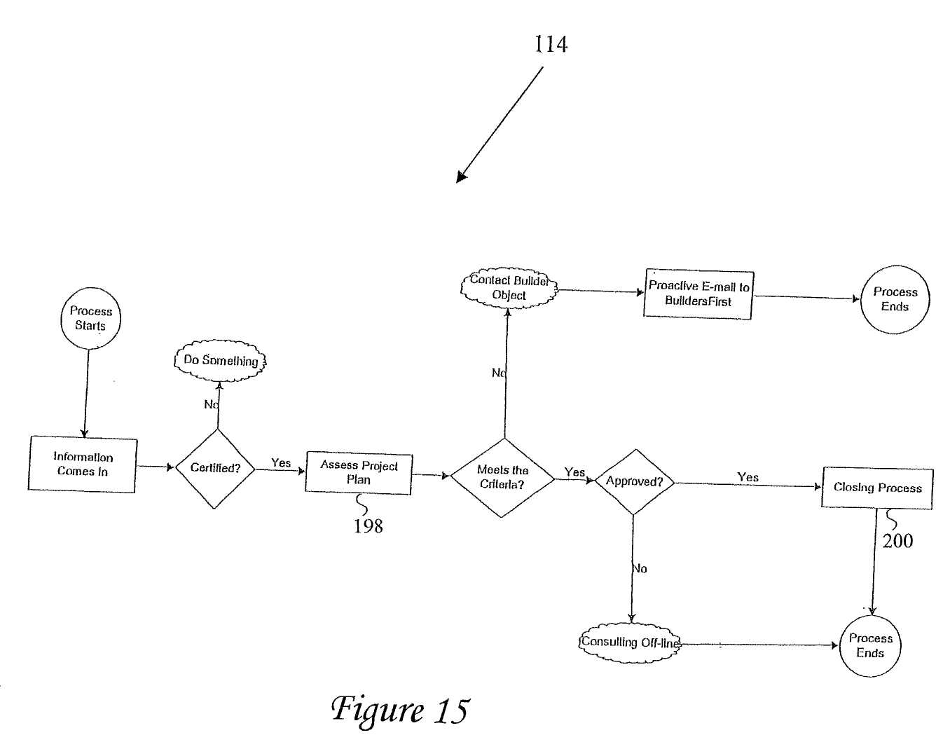

FIG. 15 is a flow diagram illustrating an exemplary underwriting process 114 utilized in the loan application process. The objective of this process is to enable builders to gain and manage loans in a more efficient and expedient manner. Once loan application information comes into the system, system administration checks to see if the builder is certified. Upon confirmation of builder certification, a system administrator assesses the submitted project plan 198. If a plan meets an established set of criteria, then the project plan is approved. Upon approval, a closing process 200 is started and any related information systems are updated with the results.

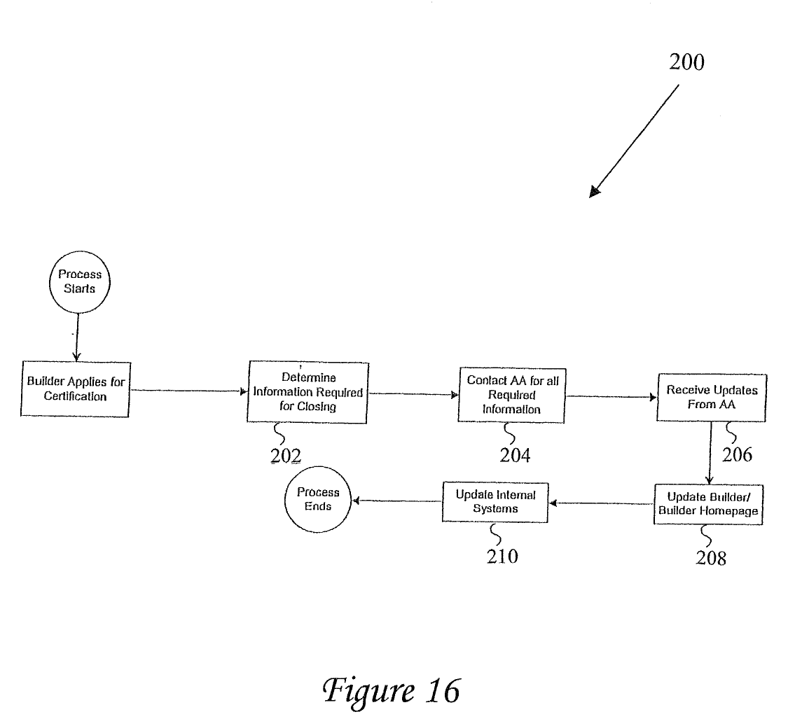

FIG. 16 is a flow diagram illustrating an exemplary closing process 200 that is a subprocess of the builder loan application process. Upon loan approval, a closing process is initiated and system administration decides which information to order 202 based upon builder registration. Next, an appraisal associate or other third party vendor is contacted 204 in regards to information that needs to be ordered. Subsequent updates are received 206 from a vendor and the builder's underwriting loan process is updated of the results/updates. A builder and builder homepage are updated 208 in regards to the closing process status. Any other related internal information systems are also updated 210 before the closing process ends.

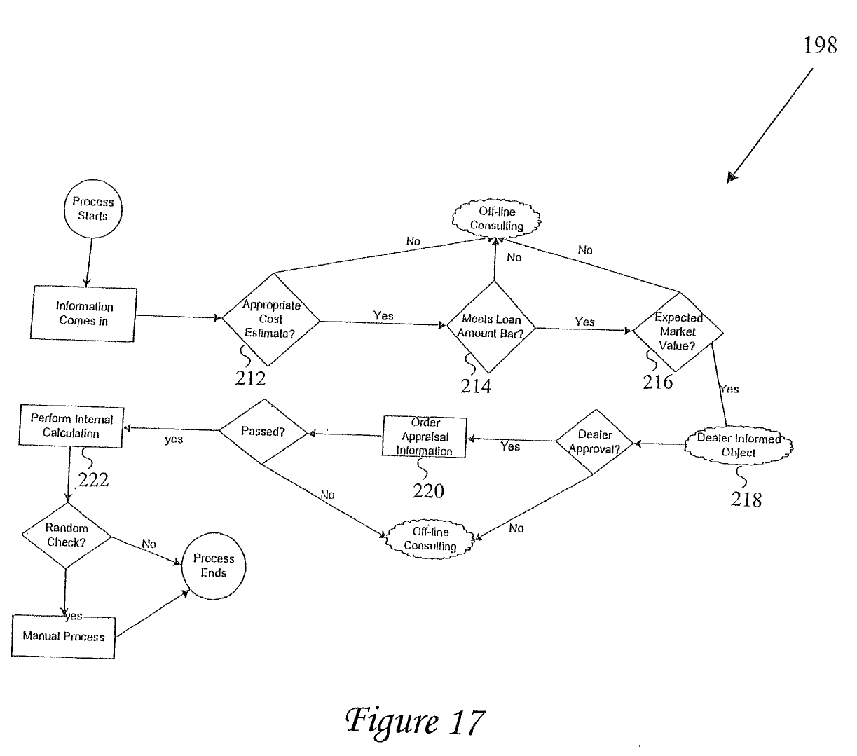

FIG. 17 is a flow diagram illustrating an exemplary project plan assessment process 198, a subprocess of the builder loan application process. After a builder has been certified and subsequently applies for a loan, a project plan must be evaluated. This underwriting subprocess helps to speed up the loan application process by proactively helping a builder establish their project plan. System administration checks to see if the project plan meets the cost estimation criteria 212 based upon builder registration information. The project plan is now checked to determine if it meets the loan amount bar criteria 214 and if it corresponds with an expected market value 216. A dealer is then contacted to obtain approval. A third party associate is contacted to order appraisal information 220. Once this information is obtained, system administration checks to see if the project plan has passed the appraisal evaluation. A final step of assessment is the system administrator performing various internal calculations 222 related to the project plan. Any related information systems are consequently updated and results are passed on to the builder loan application process.

While the invention has been described in detail with respect to specific embodiments thereof, it will be appreciated that those skilled in the art, upon attaining an understanding of the foregoing may readily conceive of alterations to, variations of and equivalents to these embodiments. Accordingly, the scope of the present invention should be assessed as that of the disclosed variation and any equivalents thereto.

What is claimed is:

1. A web-based construction application for administering selectable services to a user, said selectable services comprising:
a funding service for administering a monetary loan to a builder, wherein said monetary loan is provided to fund building-related expenses for a given construction project; and
a supply service for administering building supplies to a builder, wherein said building supplies are provided by a dealer such that a builder can utilize said building supplies for providing or assembling components or features related to a given construction project.

2. A web-based construction application as in claim 1, further comprising a registration feature wherein builders or dealers register in said web-based construction application by providing various personal and demographic data, and wherein each builder and dealer that registers in said web-based application is thereafter assigned a user name and corresponding password for future access to said web-based construction application.

3. A web-based construction application for administering selectable services to a user as in claim 1, further comprising a draw request and approval service for requesting partial payment of a monetary loan and for approving aspects of a given construction project, and wherein said monetary loan for a given construction project comprises a plurality of incremental monetary allotments, such that selected of said incremental monetary allotments are provided to a builder only after selection and completion of said draw request and approval service.

4. A web-based construction application as in claim 1, further comprising an insurance service offered to selected builders for insuring selected of the products and services utilized in selected construction projects.

5. A web-based construction application for administering selectable services to a user as in claim 3, said selectable services further comprising a project portfolio service for viewing and monitoring project, loan and draw request information relating to selected construction projects in a given portfolio of all construction projects undertaken by a given builder or dealer.

6. A web-based construction application as in claim 5, further comprising an insurance service offered to selected builders for insuring selected of the products and services utilized in selected construction projects.

7. A web-based construction application as in claim 3, further comprising a registration feature wherein builders or dealers register via said web-based construction application by providing various personal and demographic data, and wherein each builder and dealer that registers in said web-based application is thereafter assigned a user name and corresponding password for future access to said web-based construction application.

8. A web-based construction application as in claim 2, further comprising an establishment service for automatically generating an individualized home page for each builder and dealer that registers via said registration feature and for automatically assigning each builder and dealer that registers via said registration feature to a builder team, and wherein automatic assignment to a builder team is based on geographical location.

9. A web-based construction application as in claim 2, said selectable services further comprising a project portfolio service for viewing and monitoring project, loan and draw request information relating to selected construction projects in a given portfolio of all construction projects undertaken by a given builder or dealer.

10. A web-based construction application as in claim 5, further comprising a registration feature wherein builders or dealers register in said web-based construction application by providing various personal and demographic data, and wherein each builder and dealer that registers in said web-based application is thereafter assigned a user name and corresponding password for future access to said web-based construction application.

11. A web-based construction application as in claim 10, further comprising an establishment service for automatically generating an individualized home page for each builder and dealer that registers via said registration feature and for automatically assigning each builder and dealer that registers via said registration feature to a builder team, and wherein automatic assignment to a builder team is based on geographical location.

12. A web-based construction application as in claim 3, wherein said monetary loan and incremental monetary allotments thereof are provided to a funding account, and wherein said funding account is directly and electronically accessible by a builder.

13. An automated method for obtaining and administering a monetary loan for a given project, said automated method comprising the following steps:
applying for borrower initialization by providing various personal, demographic, and business-related data;
applying for a project-specific monetary loan by providing various financial information and other information specifically related to the project itself;
approving or disapproving a project-specific monetary loan by analyzing selected data and information provided in selected of said applying steps;
requesting a draw on an approved monetary loan; and
inspecting the progress of selected aspects of said given project, and consequently approving or disapproving inspected project aspects and project progress thereof.

14. An automated method for obtaining and administering a monetary loan for a given project as in claim 13, further comprising a step of depositing an allotted portion of said monetary loan to a funding account accessible by a borrower, and wherein said step of depositing an allotted portion of said monetary loan is executed only after said inspecting step results in approving inspected project aspects and project progress thereof.

15. An automated method for obtaining and administering a monetary loan for a given project as in claim 13, wherein said step of applying for borrower initialization comprises a step of applying for registration by providing specific requested information and a step of thereafter applying for certification by providing additionally specific requested information.

16. An automated method for obtaining and administering a monetary loan for a given project as in claim 13, wherein said method operates on an interconnected network which is independently and simultaneously accessible by at least one borrower and at least one inspector.

17. An automated method for obtaining and administering a construction loan for a given project as in claim 16, wherein said interconnected network resides in a web-based environment such that said method for obtaining and administering a monetary loan is employed in conjunction with an on-line loan system.

18. An automated method for obtaining and administering a monetary loan for a given project as in claim 16, wherein said step of providing information specifically related to a project is facilitated by the availability in said interconnected network of predefined project templates.

19. An automated method for obtaining and administering a monetary loan for a given project as in claim 17, wherein data and information that is analyzed in said step of approving or disapproving a project-specific monetary loan comprises both data and information that is inputted by a borrower to the online loan system as well as data and information that is requested and received off-line from a borrower.

20. An automated method for obtaining and administering a monetary loan for a given project as in claim 13, wherein said step of approving or disapproving a project-specific monetary loan comprises a step of implementing underwriting processes that automatically analyze selected data and information provided by a potential borrower.

21. An automated method for obtaining and administering a monetary loan for a given project as in claim 16, wherein said step of inspecting the progress of selected aspects of said given project, and consequently approving or disapproving inspected project aspects and project progress thereof further comprises a process wherein an inspector accesses the interconnected network and verifies via such interconnected network that project progress has been inspected and consequently approved.

22. An automated process for approving and administering a construction loan, said automated process comprising:
a builder initialization subprocess, comprising:
providing requested builder data to an on-line system;
analyzing said requested builder data; and
approving a builder for initialization in said on-line system;
a dealer initialization subprocess, comprising:
providing requested dealer data to an on-line system;
analyzing said requested dealer data; and
approving a dealer for initialization in said on-line system;
a project-specific loan application subprocess, comprising;
providing requested loan data to an on-line system;
analyzing said requested loan data; and
approving a builder for a project-specific loan; and
a draw payment subprocess, comprising:
requesting an allotted monetary increment as a draw on an approved project-specific loan;
inspecting said project progress and features thereof; and
approving the requested draw on said project-specific loan based on successful progress inspecting.

23. An automated process for approving and administering a construction loan as in claim 22, wherein said automated process is implemented in conjunction with an on-line construction application hosted on a web-based platform such as an internet website.

24. An automated process for approving and administering a construction loan as in claim 22, wherein said builder initialization subprocess comprises a registration subprocess and a certification subprocess and wherein each respective registration and certification subprocess comprises steps of respectively providing requested builder registration data and builder certification data to an on-line system, respectively analyzing said requested builder registration and builder certification data, and respectively approving a builder for registration and certification via said on-line system.

25. An automated process for approving and administering a construction loan as in claim 22, wherein said dealer initialization subprocess comprises a registration subprocess and a certification subprocess and wherein each respective registration and certification subprocess comprises steps of respectively providing requested dealer registration data and dealer certification data to an on-line system, respectively analyzing said requested dealer registration and dealer certification data, and respectively approving a dealer for registration and certification via said on-line system.

26. An automated process for approving and administering a construction loan as in claim 22, wherein said respective steps of providing requested builder data, providing requested loan data, and requesting an allotted increment on an approved loan are all performed by a prospective builder, wherein said prospective builder is characterized as one who borrows money corresponding to a construction loan for financing a construction project.

27. An automated process for approving and administering a construction loan as in claim 23, wherein selected of said respective steps of analyzing said requested builder data, analyzing said requested dealer data, and analyzing said requested loan data further comprise a respective step of employing an underwriting application for automatically analyzing selected data and information provided to said on-line system by a builder or dealer.

28. An automated process for approving and administering a construction loan as in claim 22, wherein said respective steps of providing requested dealer data and inspecting project progress and features thereof are performed by a dealer, wherein said dealer is characterized as one who oversees the construction project of a builder or builders.

29. An automated process for approving and administering a construction loan as in claim 23, wherein said respective steps of approving a builder for initialization, approving a dealer for initialization, approving a builder for a project-specific loan, and approving a requested draw on a project-specific loan are performed by a system administrator, wherein said system administrator is characterized as one who has access to and oversees the operation of said on-line construction application.

30. An automated process for approving and administering a construction loan as in claim 23, wherein said step of providing requested loan data comprises providing financial information about a builder and providing specific information about the construction project for which said project-specific loan is requested, and wherein said step of providing specific information about a construction project is facilitated by the provision via said construction application of predefined project templates.

31. An automated process for approving and administering a construction loan as in claim 22, wherein any information provided in said respective steps of providing requested builder data to an on-line system, providing requested dealer information to an on-line system, and providing requested loan data to an on-line system, that is not or cannot be provided online is requested from said builder or said dealer for off-line receipt thereof.

32. An automated process for approving and administering a construction loan as in claim 25, further comprising a construction supply subprocess, said construction supply subprocess comprising the steps of:
requesting building supplies for use in a given construction project, wherein said step of requesting building supplies is performed by an approved builder; and
approving a request for building supplies, wherein a request for building supplies can be approved by selected one of an approved dealer and a system administrator.

33. An automated process for approving and administering a construction loan as in claim 30, wherein said monetary funding is provided by a lender to a funding account such that draws on an approved loan are accessible to a builder from said funding account.

34. An automated process for approving and administering a construction loan as in claim 32, wherein said construction supplies are provided by a dealer who has been approved for registration and certification via said on-line system.

35. A web-based application for providing a multi-level construction system, featuring integrated and automated on-line project financing and ordering of building supplies, said web-based application comprising the following selectable services:
a registration service, available to prospective builders or dealers, for registering in said web-based application;
a certification service, available to registered builders or dealers, for obtaining certification to participate in said multi-level construction system;
a loan application service, available to builders, for requesting monetary funding for a construction project;
a draw request service, available to builders, for requesting an allotted increment of an approved loan; and
an inspection verification service, available to dealers, for verifying progress on a given project and for providing corresponding partial project approval.

36. A web-based application for providing a multi-level construction system as in claim 35, further comprising an insurance service offered to selected builders for insuring selected products and services utilized in a given construction project.

37. A web-based application for providing a multi-level construction system as in claim 35, further comprising a project portfolio service for viewing and monitoring project, loan and draw request information relating to selected construction projects in a given portfolio of all construction projects undertaken by a given builder or dealer.

38. A web-based application for providing a multilevel construction system as in claim 35, further comprising a tutorial service for providing aided system instruction to a builder or dealer as related to selected of the services offered via said web-based application.

39. A web-based application for providing a multilevel construction system as in claim 35, wherein a builder or dealer is automatically prompted to select said certification service after selection and completion of said registration service.

40. A web-based application for providing a multilevel construction system as in claim 35, wherein a unique home page is generated for each builder or dealer that selects and completes said registration service, and wherein each respective builder or dealer is also assigned, upon selection and completion of said registration service, a username and corresponding password for future access to selected services offered via said web-based application.

41. A web-based application for providing a multilevel construction system as in claim 35, wherein a builder or dealer is automatically assigned to a builder team, with assignment thereof based on geographic location, and wherein a builder or dealer is assigned to a builder team after selection and completion of said registration service.

42. A web-based application for providing a multilevel construction system as in claim 35, further comprising a plurality of predefined project templates, for use in conjunction with said loan application service, and for facilitating provision of information related to a specific construction project by a builder to said web-based application.

43. A web-based application for providing a multilevel construction system as in claim 35, further comprising a monetary deposit service wherein, upon selection and completion of said draw request service by a builder in a selected builder team and corresponding selection and completion of said inspection verification service by a dealer in said selected builder team, an allotted increment of an approved loan is automatically provided to a funding account, whereby said funding account and any funds therein are accessible by said builder.

44. A web-based application for providing a multi-level level construction system as in claim 35, further comprising an automatic analysis service for gathering selected information provided in conjunction with selected services, for analyzing said selected information online, and for returning an approval or disapproval of said analyzed selected information.

45. A web-based application for providing a multilevel construction system as in claim 35, further comprising a supply service whereby a builder requests certain building supplies for use in a specific construction project such that a dealer thereafter provides said builder with selected requested building supplies.

46. A web-based communications network for automatically administering a controlled relationship between a borrower and an inspector for automated construction loan financing, comprising:
an initialization service for registering and certifying potential borrowers and potential inspectors in accordance with network administered standards;
a funding account service for storing monetary funding from a lending source in a funding account for association with a specific potential borrower, and for association with a specific construction loan associated with a specific construction project; and
an automated draw request service for facilitating inspection by a registered and certified inspector of progress on a specific construction project and for facilitating transfer, based on such inspector approval, of a monetary allotment of an associated specific construction loan from the lending source to an associated specific funding account, accessible by the associated borrower, such that an automated controlled relationship provides funding for construction financing without requiring a direct loan to a borrower.

47. A web-based communications network for automatically administering a controlled relationship between a borrower and an inspector as in claim 46, wherein said web-based communications network is accessible by a system administrator, wherein said system administrator controls and manages aspects of selected of said initialization service, said funding account service, and said automated draw request service .

48. A web-based communications network for automatically administering a controlled relationship between a borrower and an inspector as in claim 46, further comprising a building supply service for providing a registered and certified borrower with selected building supplies from an associated registered and certified inspector or other authorized source, wherein such building supplies are provided for intended association with a specific construction project.

49. A web-based communications network for automatically administering a controlled relationship between a borrower and an inspector as in claim 46, further comprising a builder team designation service wherein selected registered borrowers and selected registered inspectors are automatically assigned to a specific builder team, and wherein automatic assignment to a builder team is based on geographical location.

50. A web-based communications network for automatically administering a controlled relationship between a borrower and an inspector as in claim 48, wherein said web-based communications network further administers a controlled relationship among such a borrower and such an inspector, and also among a funding account and a subcontractor, such that such subcontractor provides monetary funding to a funding account or provides building supplies to a registered and certified borrower or to a registered and certified inspector.
